(19) United States
(12) Patent Application Publication
(10) Pub. No.: US 2004/0247854 A1
(43) Pub. Date: Dec. 9, 2004

(54) Foaming tool and intermediate composite part produced via a foaming tool

(76) Inventors: Matthias Ludwig, Vechelde (DE); Marcus Lutz, Gifhorn (DE); Frank Niebuhr, Wilsche (DE); Harald Batke, Gerstenbuttel (DE)

Correspondence Address: CARLSON, GASKEY & OLDS, P.C., 400 WEST MAPLE ROAD, SUITE 350, BIRMINGHAM, MI, 48009, US

(21) Appl. No.: 10/855,228

(22) Filed: May 27, 2004

(30) Foreign Application Priority Data
Jun. 5, 2003 (DE) 103 25 619.9

(51) Int. Cl. B29C 44/12

(52) U.S. Cl. 428/304.4; 264/46.4; 425/4 R; 425/817 R; 425/127; 428/318.4

(57) ABSTRACT

A foaming tool has a first mold part, a second mold part, and at least two cavities for producing at least two composite parts from a substrate. A compensation zone is disposed between the two cavities and is adapted to accommodate a relief zone formed on the substrate. The substrate has a first component section and a second component section adapted to be arranged in the cavities of the foaming tool. The first and second component sections receive a foamed backing of an expandable material to form the composite parts. The substrate has a relief zone between the first and second component sections to handle any stresses on the substrate and prevent surface defects in the substrate.

### REFERENCE TO RELATED APPLICATIONS

The present invention claims the benefit of German Patent Application No. 103 25 619.9, filed Jun. 5, 2003.

### TECHNICAL FIELD

The invention relates to a foaming tool having a first mold part and a second mold part. The first and second mold parts define at least two cavities to produce at least two components containing a substrate. The invention further relates to a substrate comprising a first component section and a second component section adapted to be arranged in the cavities of the foaming tool to receive a foamed backing of an expandable material.

### BACKGROUND OF THE INVENTION

Composite parts, such as vehicle body parts or add-on parts for a motor vehicle, may be produced by forming a foamed backing from expandable synthetic material, such as polyurethane, onto a substrate. The substrate may be, for example, a thermoplastically deformed plastic film or metal foil. The substrate is placed in a first mold part of a foaming tool. The expandable material is deposited on the substrate, and the foaming tool is closed via a second mold part.

When the expandable material expands and reacts, heat is released and causes thermally induced elongation in the foamed backing. This produces stresses in the substrate, which may form delineations on the side of the substrate that will eventually be an exterior side of the composite part. The delineations are clearly visible as streaks on the exterior side, undesirably marring the surface quality of the composite part. The stress generation problem is particularly severe if two components are to be produced simultaneously in one foaming tool and in one working step from a single contiguous substrate.

There is a desire for a foaming tool and a substrate that prevent substrate degradation due to stresses occurring during the foaming process.

### SUMMARY OF THE INVENTION

The invention is directed to a foaming tool having at least two cavities for forming at least two composite parts simultaneously. The foaming tool has a compensation zone between the two cavities that accommodates a relief zone formed on a substrate. The compensation zone between the two cavities in the foaming mold allows the relief zone in the substrate to bend slightly during the foaming process to reduce stress generation in the substrate. This compensation zone is expediently located between areas where heat input occurs, i.e. between the cavities.

The relief zone on the substrate may be in the form of a relief channel that has a shape, such as a curved shape, that is comparably easy to deform. The relief zone provides an area for the substrate to bend into during the foaming process to relieve any stresses in the substrate and therefore to result in a better appearance for the final composite parts.

Advantageous designs of the invention will be apparent from the sub-claims.

### BRIEF DESCRIPTION OF THE DRAWINGS

The invention will be described in the following with the aid of the embodiments illustrated in the attached drawings in which:

FIG. 1 is a schematic sectional view of a foaming tool with a substrate placed therein according to one embodiment the invention;

FIG. 2 is a top view of the substrate shown in FIG. 1;

FIG. 3 is an enlarged view of a detail III of FIG. 1, where the substrate is shown before the foaming process;

FIG. 4 is a view corresponding to the view shown in FIG. 3 illustrating the substrate after the foaming process;

FIG. 5 shows a further processing step of the substrate after the foaming process;

FIG. 6 is a perspective view of a mold part in a foaming tool according to one embodiment of the invention; and

FIG. 7 is a schematic top view of a substrate according to another embodiment of the invention.

### DETAILED DESCRIPTION OF THE EMBODIMENTS

The invention is generally directed to a foaming tool having at least two cavities for forming at least two composite parts and a compensation zone between the cavities. The compensation zone is adapted to accommodate a relief zone formed on a substrate used in the composite parts. The compensation zone allows the relief zone to bend when a foamed material is formed on the substrate, thereby reducing the generation of stresses in the substrate. This compensation zone is preferably located between zones where the heat input occurs, i.e. between the two cavities.

The relief zone in the substrate is formed between sections of the substrate that will eventually be in the composite parts (i.e., component sections). The relief zone in the substrate has reduced strength or reduced resistance against longitudinal elongation, allowing the relief zone to be integrated with the component sections into a single substrate so that the component sections extend into the relief zone. The relief zone also provides a simple way to include compensating tolerances in the substrate to accommodate tools, such as a forming tool, a foaming tool and a finishing tool, that are used sequentially during manufacturing of the composite parts.

The relief zone may be formed as a relief channel that is curved and is therefore comparably easy to deform. The relief channel configuration is advantageous because it has a particularly high resistance to bending loads that are applied about an axis transverse to the direction in which the relief channel extends. This allows reliable handling of the substrate during the various manufacturing steps required for producing the composite part.

The relief zone may also be formed as a gap-like cut-out between the two component sections. This relief zone configuration may be accomplished by, for example, stamping out at least one material strip from the substrate. This type of relief zone has a particularly low strength and allows substrate material to bend into the relief zone during the foaming process to relieve stresses in the component sections of the substrate. For this type of substrate, the foaming tool does not need a special configuration in its compensation zone to accommodate the relief zone.

Note that although the description below focuses on a foaming tool and substrate for forming two composite parts, the inventive concept can easily accommodate any number of composite parts without departing from the scope of the invention.

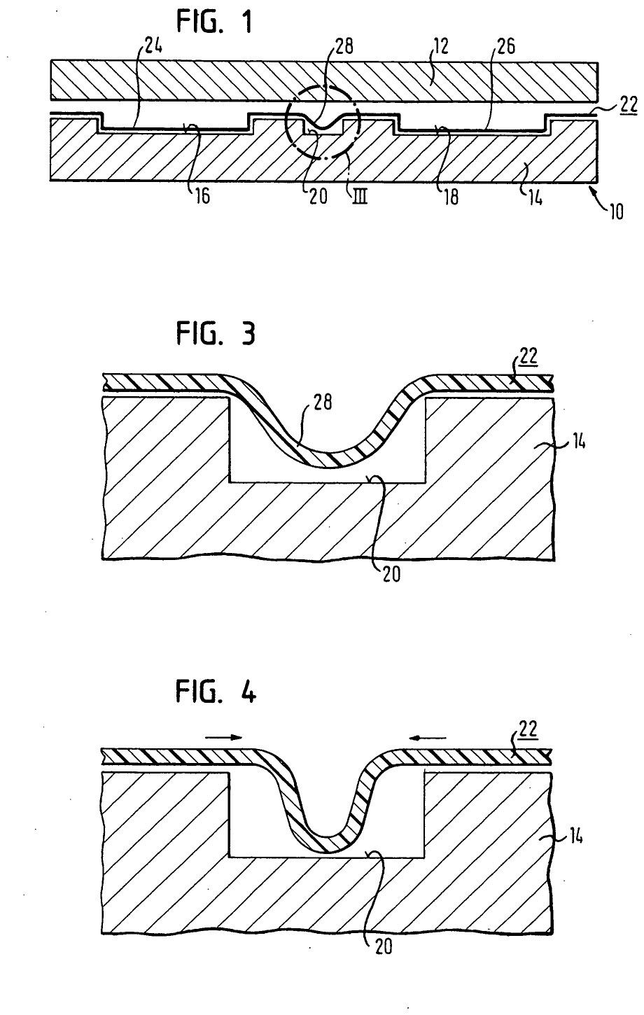

Referring now to the figures, FIG. 1 is a schematic diagram of a foaming tool 10 having an upper part 12 and a lower part 14. A first cavity 16 and a second cavity 18 are formed in the lower part 14 of the foaming tool 10. A compensation zone 20 is formed between the first cavity 16 and the second cavity 18. In the embodiment shown in FIG. 1, the compensation zone 20 is configured as a groove with a rectangular cross-section in the lower part 14 of the foaming tool 10. Alternatively, the compensation zone 20 can be provided in an upper part (not shown) of the foaming tool 10. The compensation zone 20 may also have other configurations, such as a simple planar area between the first and second cavities 16, 18, depending on a shape of a substrate to be placed in the forming tool 10

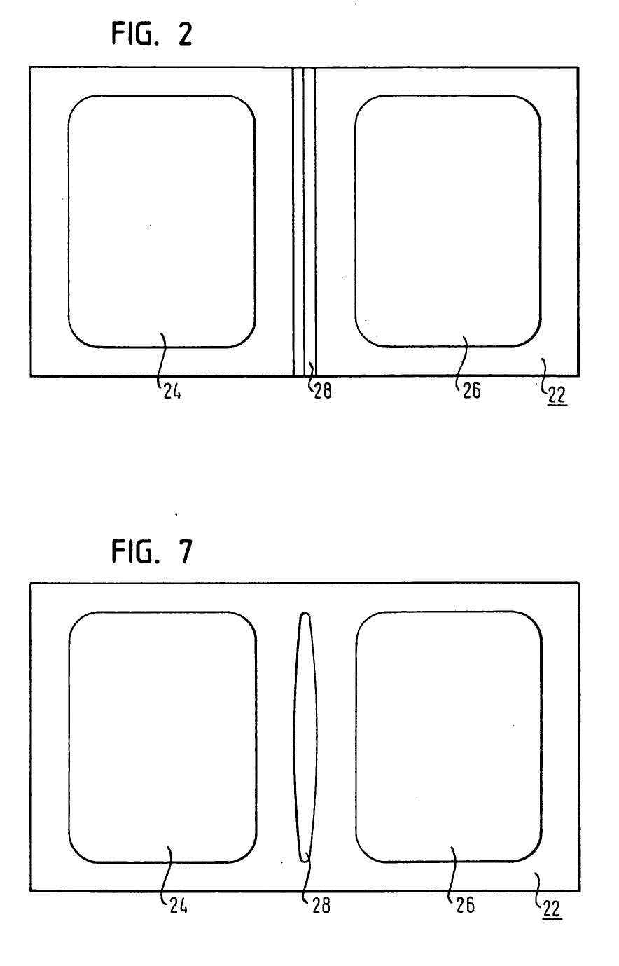

As show in FIGS. 1 and 2, a substrate 22 is placed on the lower part 14 of the foaming tool 10. The substrate itself may be made of a deep-drawn film of a thermoplastic synthetic material, aluminum, aluminum alloy, or any other appropriate material. The substrate 22 has a first component section 24 associated with the first cavity 16 in the foaming tool 10 and a second component section 26 associated with the second cavity 18 in the foaming tool 10. A relief zone 28 is formed in the substrate 22 between the first and second component sections 24, 26. The relief zone 28 may be configured as a rounded relief channel (FIG. 3). In this example, the relief zone 28 in the substrate 22 lies in the compensation zone 20 of the lower part 14 of the foaming tool 10.

During manufacturing of composite parts, a predetermined amount of expandable material 30, such as polyurethane, is applied on the first and second component sections 24, 26 of the substrate 22. The foaming tool 10 is then closed to allow the expandable material 30 to react and cure to form a foamed backing on the substrate 22. During the reacting and curing process, the expandable material 30 generates heat, causing portions of the substrate 22 to elongate. The resultant heat-induced elongation causes the first and second component sections 24, 26 of the substrate 22 to flow into their respective first and second cavities 16, 18. Excess substrate 22 material resulting from this elongation causes the relief channel forming the relief zone 28 to be compressed (FIG. 4). Because the relief zone 28 is configured to deform easily, the relief zone 28 can be deformed via application of low level forces to accommodate any stresses in the substrate 22, eliminating the chance of harmful stresses building up in the component sections 24, 26.

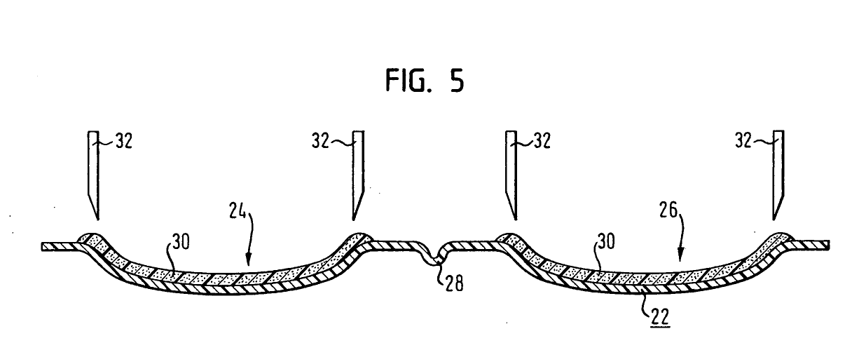

FIG. 5 shows the substrate 22 configuration when it is removed from the foaming tool 10. As can be seen in the figure, the substrate 22 has a foamed backing formed from the foamed expandable material 30 in the first and second component sections 24, 26. The relief zone 28 is still disposed between the first and second component sections 24, 26 at this stage. To obtain the finished composite parts, edge portions of the substrate 22, including any overlying foamed expandable material 30, are severed by blades 32 to separate the composite parts from each other and from any excess substrate 22 and foamed expandable material 30. During this severing step, the relief zone 28 will also be separated from the composite parts.

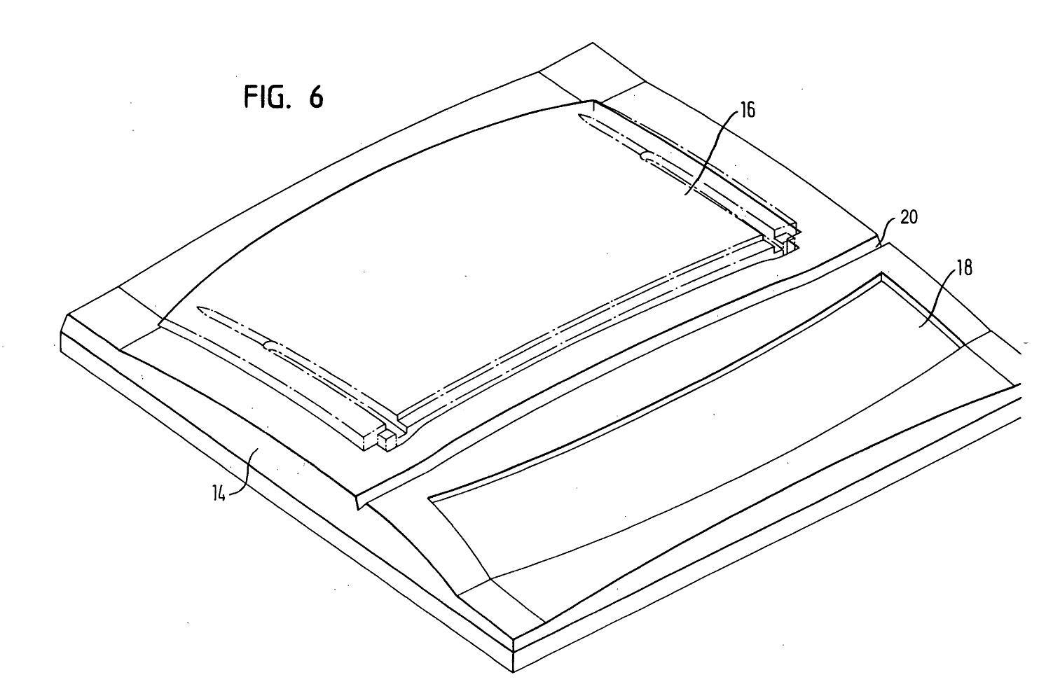

FIG. 6 is a perspective view of an example of the lower part 14 of the foaming tool 10. In this example, the compensation zone 20 is a groove having a V-shaped cross-section and that extends across the entire width of the lower part 14. Alternatively, the compensation zone 20 may have a U-shaped cross-section. The compensation zone 20 may alternatively be disposed in the upper part (not shown) of the foaming tool 10.

FIG. 7 shows an alternative embodiment of the substrate 22. In this embodiment, the relief zone 28 is a gap-like cut-out section. The cut-out section may be obtained by, for example, stamping or any other cutting method. This relief zone 28 configuration is advantageous because it does not require the compensation zone 20 to have any special configuration for accommodating compression of the relief zone 28. Instead, any excess material in the substrate 22 can flow into the cut-out section to relieve stress. However, the disadvantage of this embodiment is that the strength of the substrate is reduced due to the cut-out section, making handling of the substrate 22 somewhat more complicated, particularly during insertion and removal of the substrate 22 from the foaming tool 10.

It should be understood that various alternatives to the embodiments of the invention described herein may be employed in practicing the invention. It is intended that the following claims define the scope of the invention and that the method and apparatus within the scope of these claims and their equivalents be covered thereby.

1. A foaming tool comprising:
a first mold part;
a second mold part;
first and second cavities formed in one of the first mold part and the second mold part for producing at least two composite parts containing a substrate; and
a compensation zone disposed generally between the first and second cavities to accommodate a relief zone on the substrate.

2. The foaming tool according to claim 1, wherein the compensation zone creates an area to accommodate shifting of the substrate when stress occurs on the substrate.

3. The foaming tool according to claim 1, wherein the compensation zone is a groove.

4. The foaming tool according to claim 3, wherein the groove extends across an entire width of the foaming mold.

5. The foaming tool according to claim 3, wherein the groove has one of a U-shaped cross-section and a V-shaped cross-section.

6. The foaming tool according to claim 3, wherein the groove has a rectangular cross-section.

7. A substrate, comprising:
a first component section;
a second component section, the first and second component sections adapted to be arranged in first and second cavities of a foaming tool and to receive an expandable material to be formed into a foamed backing; and
a relief zone formed between the first and second component sections to relieve stress in the substrate when the foamed backing is formed.

8. The substrate according to claim 7, wherein the relief zone is a gap-like cut-out.

9. The substrate according to claim 7, wherein the relief zone is a relief channel.

10. The substrate according to claim 7, wherein the expandable material applied to the substrate extends near the relief zone to form first and second composite parts.

11. The substrate according to claim 10, wherein at least one of said first and second composite parts is a roof module.

12. A method of producing a composite part, comprising:
placing a substrate having at least two component sections and a relief zone between said at least two component sections into a foaming mold;
applying a foamed backing to said at least two component sections, wherein the relief zone relieves any stress in the substrate resulting from the applying step; and
removing the relief zone from said least two component sections.
